(19) United States
(12) Patent Application Publication
(10) Pub. No.: US 2017/0118087 A1
(43) Pub. Date: Apr. 27, 2017

(54) Computer Network Modeling

(71) Applicant: Stackray Corporation, Mill VAlley, CA (US)

(72) Inventor: David Bergman, New York, NY (US)

(21) Appl. No.: 15/365,257

(22) Filed: Nov. 30, 2016

Related U.S. Application Data
(63) Continuation of application No. PCT/US16/47920, filed on Aug. 19, 2016.
(60) Provisional application No. 62/207,369, filed on Aug. 19, 2015.

(51) Int. Cl. H04L 12/24; G06F 17/50

(52) U.S. Cl. CPC H04L 41/145; G06F 17/5009; H04L 41/046

(57) ABSTRACT

Disclosed, in one general aspect, is a computer-based method for automatically detecting characteristics of a computer system that includes different running servers connected by a digital communication network. The method includes running resource identification agents over the digital communication network on each different targeted server in the network, receiving machine-readable network interface information for the targeted servers from the agents through the digital communication network, and receiving machine-readable information about functionality present on the targeted servers from the agents through the digital communication network. A machine-readable model of interactions among the targeted servers in the computer network is built and stored based on the received information, and characteristics of the computer system are detected from the stored machine-readable model.

### CROSS-REFERENCE TO RELATED APPLICATION

This application is a continuation of PCT application no. PCT/US2016/047920, filed Aug. 19, 2016, which claims priority to provisional application No. 62/207,369, filed Aug. 19, 2015, which are both herein incorporated by reference.

### FIELD OF THE INVENTION

This invention relates to methods and apparatus for analyzing computer networks, such as by building and analyzing models of such networks.

### BACKGROUND OF THE INVENTION

Networked computer systems consisting of networked computers that generally each run an operating system and a variety of other software applications are now ubiquitous and are notably found in corporate and government organizations. These generally include computers, such as workstations and servers, that are interconnected via a communication network, such as via an internet protocol (IP) network. Each computer can run a variety of different programs and these programs can communicate with each other via the network. But as these systems increase in size and scope, often spanning tens or hundreds of server instances and thousands of processes, it becomes more and more difficult to fully understand them.

### SUMMARY OF THE INVENTION

In one general aspect, the invention features a computer-based method for automatically detecting characteristics of a computer system that includes different running servers connected by a digital communication network. The method includes running resource identification agents over the digital communication network on each different targeted server in the network, receiving machine-readable network interface information for the targeted servers from the agents through the digital communication network, and receiving machine-readable information about functionality present on the targeted servers from the agents through the digital communication network. A machine-readable model of interactions among the targeted servers in the computer network is built and stored based on the received information, and characteristics of the computer system are detected from the stored machine-readable model.

In preferred embodiments, the step of building and storing a machine-readable model can include storing and building a model that includes information about how sub-systems and high-level services interconnect. The step of receiving information about functionality present on the targeted servers can include receiving information about open files, configuration files, operating system files, open sockets, and process-level information present on the servers, with the step of receiving machine-readable network interface information for the targeted servers including receiving IP addresses for the targeted servers. The step of detecting characteristics of the computer system can include detecting network security, stability, scalability, and/or deployment characteristics for the computer system. The step of building and storing a model can builds and store a model that includes a process layer that contains process-level information for the system derived from the agents, a connection layer that contains information about communication between processes derived from the fundamental layer, and a service layer that includes information about services derived from the connected layer. The steps of sending, receiving, and building can operate on a computer system that includes virtualized servers and virtualized communication layers. The step of receiving replies can include a step of receiving information formatted according to the RDF resource discovery model. The method can further include the step of displaying a visual representation of the computer system based on the model. The step of detecting characteristics of the computer system can include cataloging technologies available on the servers in the computer system. The method can further include the step of repeating the steps of running and receiving after an update to the architecture of the computer system, and further including the step of updating the stored model to reflect the updated architecture of the computer system. The step of running the agents can terminate without leaving any stored information on the servers. The steps of running and receiving can be performed by generic and specific gatherers.

In another general aspect, the invention features an agent including stored instructions operative to run on a computer system server and report information about the computer system server. The agent includes a network interface gatherer operative to gather machine-readable information about a network interface of the computer system server, a file information gatherer operative to gather information about files on the computer system server, a process information gatherer operative to gather information about processes on the computer system server, and a reporting module operative to report results from the network interface gatherer, the file information gatherer, and the process information gatherer through a communication network to a modeling server. In preferred embodiments, the agent can be implemented using a scripting language.

In a further general aspect, the invention features a computer-based system for automatically detecting characteristics of a computer system that includes a plurality of different running servers connected by a digital communication network. The system includes means for running a plurality of resource identification agents over the digital communication network on each of a plurality of different targeted servers in the network, means for receiving machine-readable network interface information for the targeted servers from the agents through the digital communication network, means for receiving machine-readable information about functionality present on the targeted servers from the agents through the digital communication network, means for building and storing a machine-readable model of interactions among the targeted servers in the computer network based on the received information, and means for detecting characteristics of the computer system from the stored machine-readable model.

Systems according to the invention can be designed to build models non-invasively and automatically from running complex and distributed software systems, often spanning hundreds or thousands of servers (target systems). They can employ a unique method to achieve a high fidelity model of various aspects of a target system, such as the factual network topology, how sub systems interconnect, how high-level services interconnect, all the way down to detailed process level, including what files and sockets are open and the meta data for crucial initialization and configuration files.

Models created by systems according to the invention can then be used in various related applications, such as (i) architectural overview of a target system, (ii) analysis of security risks, including improper connection between parts or insecure use of files, (iii) analysis of stability/scalability, including potential single points of failures, and (iv) generating a streamlined automatic deployment harness for a target system, suitable for modern deployment scenarios in public or private clouds.

Systems according to the invention can be implemented in such a way as to allow organizations to, in an automatic fashion, get the underlying architecture and topology of a complex software system, the target system, as well as pinpointing problems with scalability, stability and security, and also simplify the transition of the system onto a more flexible and scalable foundation in a public or private cloud. And all that can be derived from a running target system, without any installations required.

Systems according to the invention can provide a significant improvement over prior art network management procedures in which existing software architecture or system documents are often outdated, or even non-existing. Using such prior art systems in businesses environments often results in:
Keeping IT operations staff members around solely for crucial information about the software system they happen to have internalized. This can add to maintenance costs.
Making it a tedious and sometimes impossible task to create a new test or QA environment. It can take months to gather the information to set up a new environment.
Making moving the system to a cloud solution a long and expensive task, often spanning a year or more.
Not understanding security vulnerabilities of an entire system and its composition and interconnectedness, which can lead to security breaches.
Not knowing where potential bottlenecks and single points of failure exist in the system, which can affect both scalability and stability of the system.
Having unused technologies in the system, which could be purged, adding to complexity.
Not even knowing what technologies are being used in the system. Systems according to the invention can be designed to address these kinds of issues, as discussed in more detail below.

### BRIEF DESCRIPTION OF THE DRAWINGS

FIG. 1 is a block diagram of an illustrative model building and analysis system according to the invention;

FIG. 2 is a block diagram of an illustrative target network to be modeled by the system of FIG. 1;

FIG. 3 is a block diagram of the target network of FIG. 2 showing the deployment of generic information gathering agents,

FIG. 4 is a block diagram of the target network of FIG. 2 showing the process layer of the target network as detected by the generic information gathering agents,

FIG. 5 is a block diagram of the target network of FIG. 4 shown after termination of the generic information gathering agents,

FIG. 6 is a block diagram of the target network of FIG. 2 showing the connection layer of the target network as detected by specific information gathering agents and refined by the process connector,

FIG. 7 is a block diagram of the target network of FIG. 2 showing the service layer of the target network as detected by the specific information gathering agents and refined by the service analyzer,

FIG. 8 is a flowchart illustrating the operation of the system of FIG. 1 on the target network of FIG. 2,

FIG. 9A is a visualization of a semantic graph for the Connected Stratum of the Meta Model for Appendix I,

FIG. 9B is a top half of the model of FIG. 9A;

FIG. 9C is a bottom half of the model of FIG. 9A;

FIG. 10 is a visualization of the semantic graph for the Connected Stratum of the Meta Model for Appendix I, and

FIG. 11 is a visualization of the semantic graph for the Service Stratum of the Meta Model for Appendix I.

### DETAILED DESCRIPTION OF AN ILLUSTRATIVE EMBODIMENT

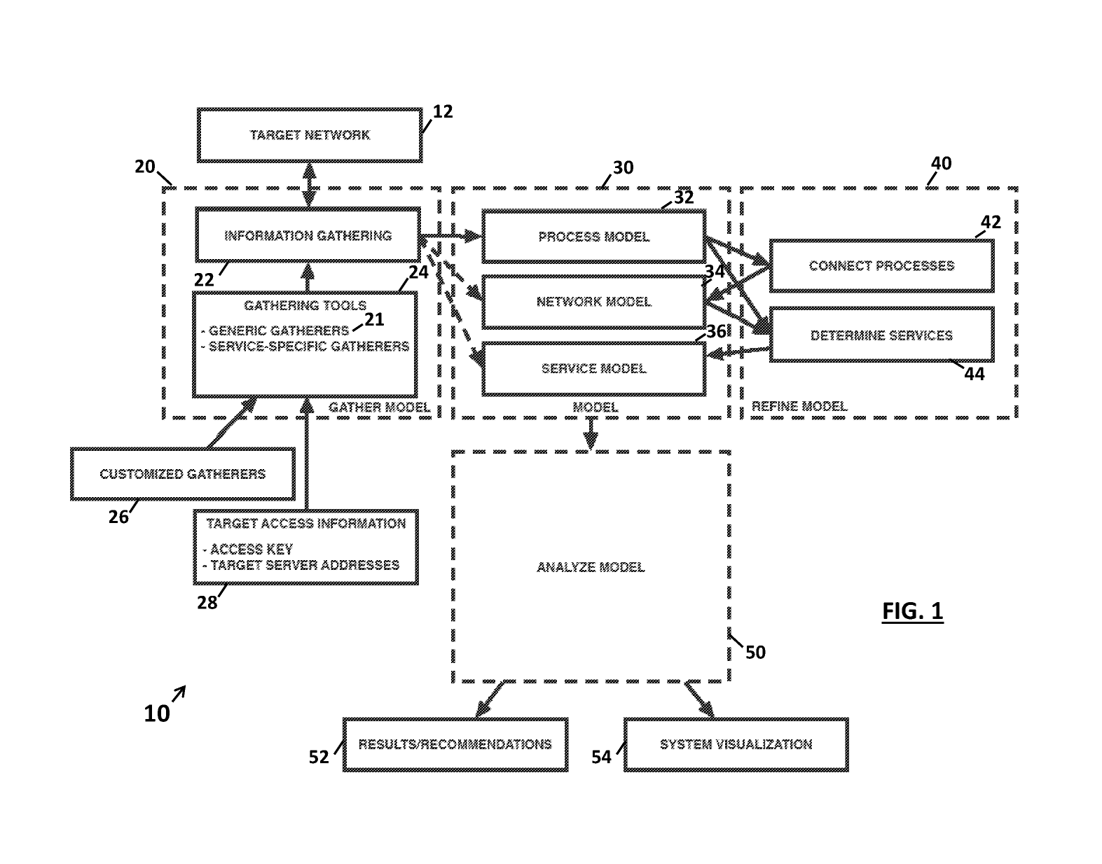

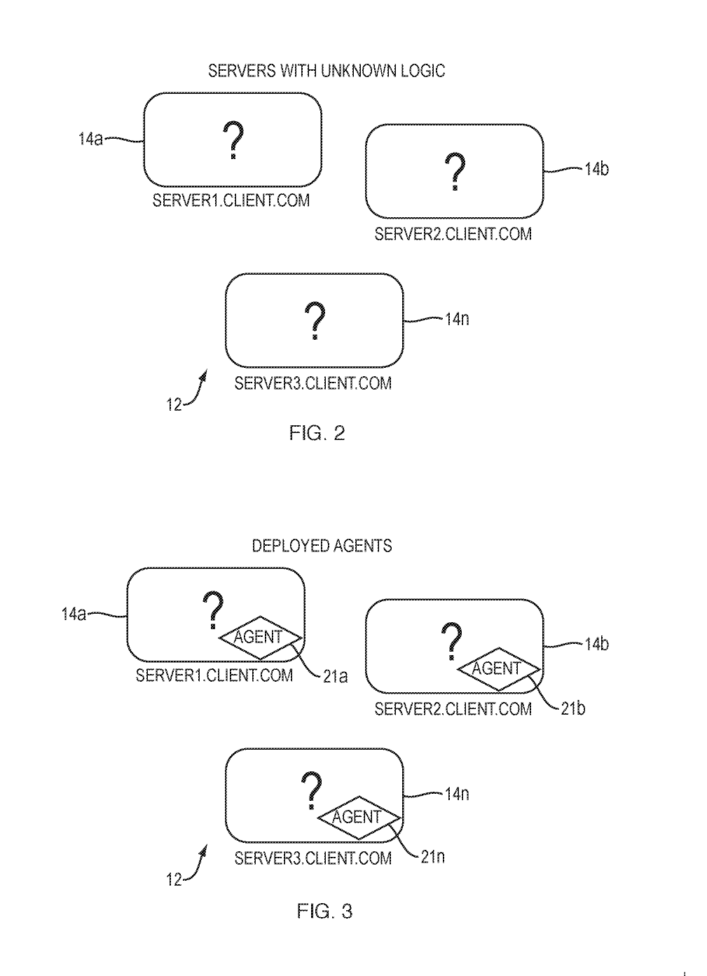

Referring to FIGS. 1 and 2, a model building and analysis system 10 according to the invention includes an information gathering subsystem 20 that can be connected to a running target network 12 that includes a plurality of computers 14a, 14b . . . 14n. The information gathering subsystem includes an information gathering controller 22 that is responsible for deploying information gatherers of different types on the various computers on the target network, and using returned information to build a stratified model of the particular target system in model storage 30 based on a meta model that will be described in more detail below. A model refinement subsystem 40 is also provided to refine the model. And a model analysis subsystem 50 is provided to analyze the model and thereby derive analysis results, such as system visualizations 54 as well as listings of results, and/or recommendations for modifications of the system 52.

The model storage 30 can be implemented using a database and is divided into three parts. These store three parts of the model, including the process model layer 32, the connection model layer 34, and the service model layer 36. The model refinement subsystem 40 includes a process connector 42 and a service analyzer 44 that can each refine the model.

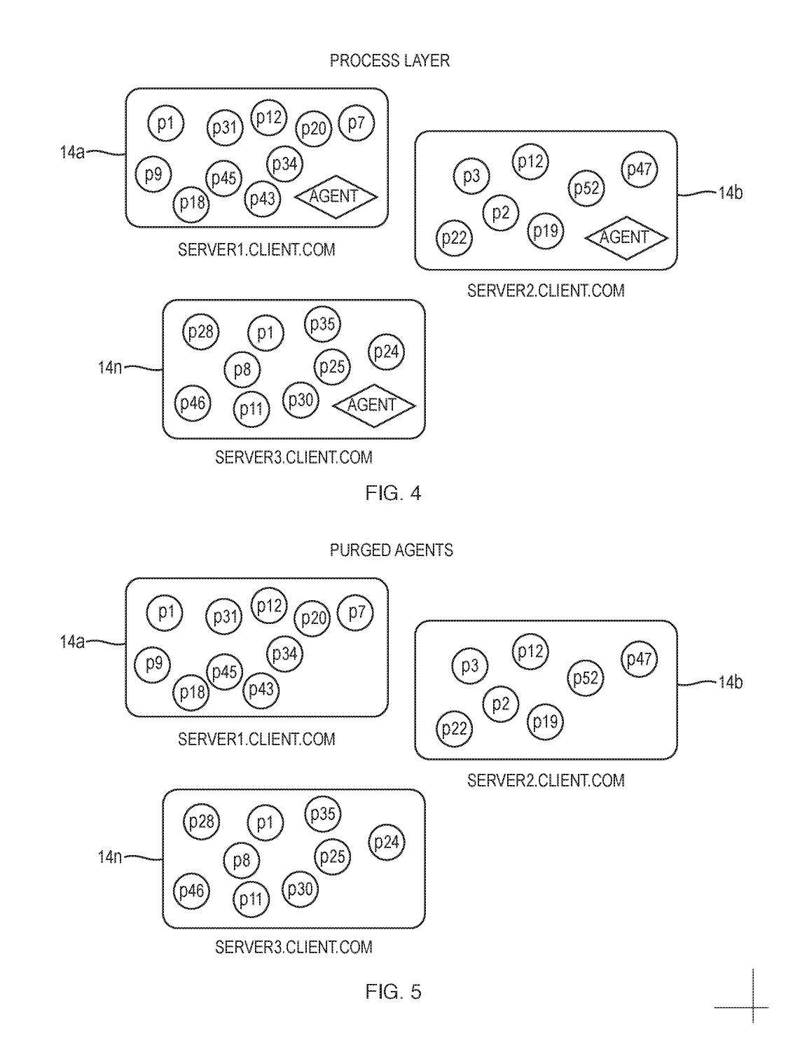

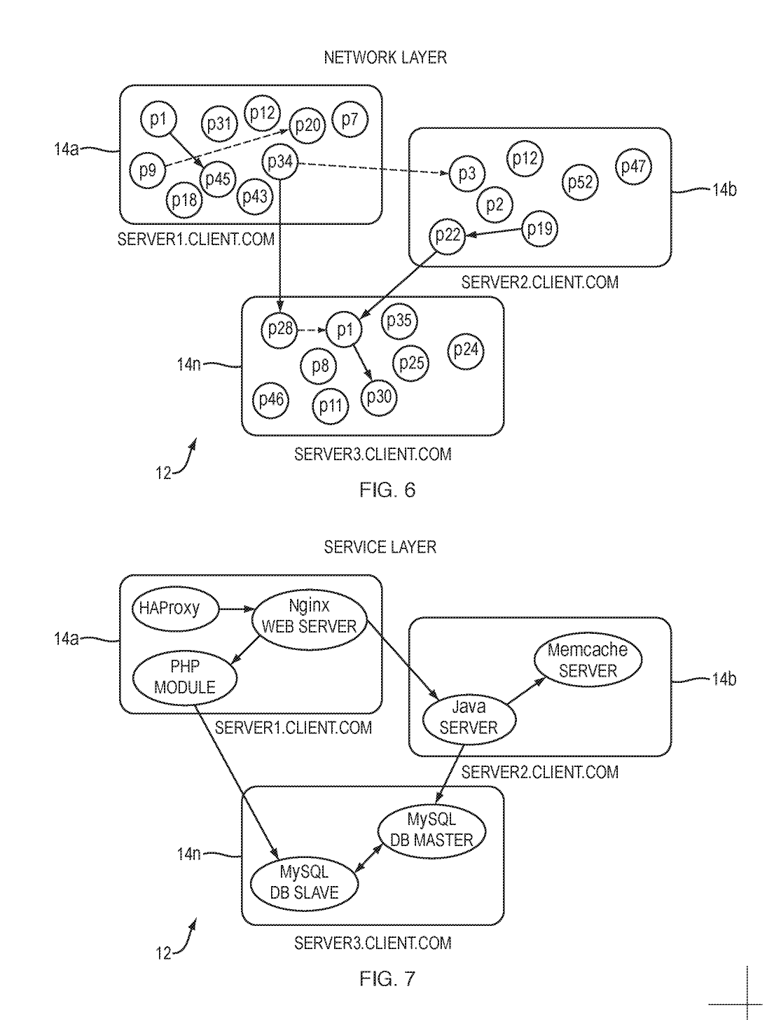

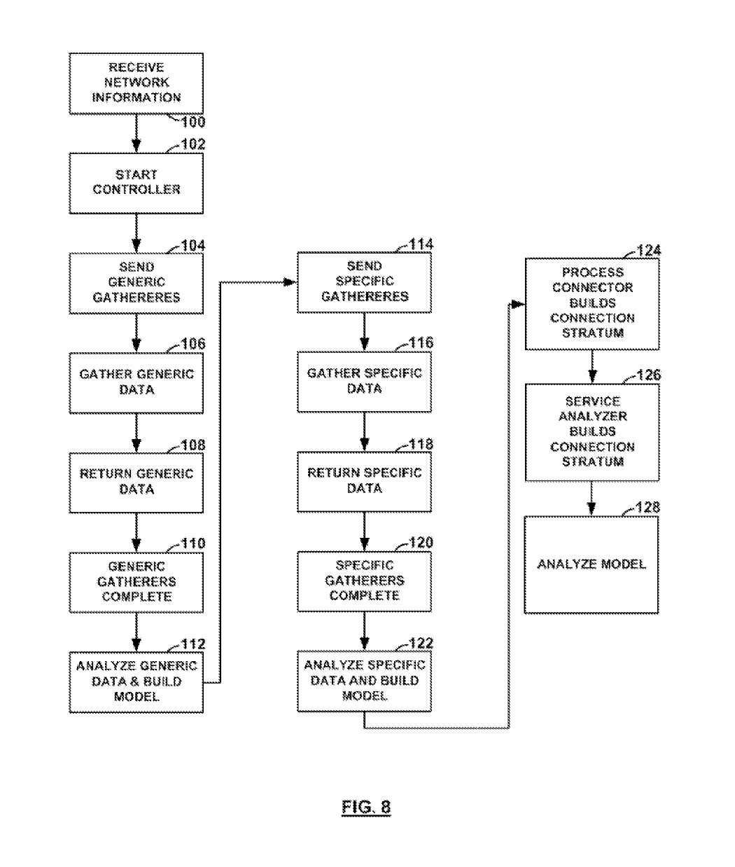

In operation, referring to FIGS. 1-8, the information gathering subsystem 20 receives information about the computers in the target network 12, such as their network addresses and corresponding access information (step 100). In this embodiment the operator provides this information manually, and it includes the IP addresses of all machines, virtual or not, partaking in the execution of the target system, virtual or not, and also the path to an SSH private key file. This is provided in a simple text file that the operator can edit.

The information gathering subsystem 20 then begins operation by launching the information gathering controller 22 (step 102). This controller can be implemented as a command-line tool executed on an operations workstation computer that triggers all actions and sends agents to target servers, as discussed below.

The controller starts by sending generic gatherers 21a, 21b . . . 21c to each of the machines 14a, 14b, . . . 14c listed in the SSH private key text file (step 104). One generic gatherer is sent per item of information sought, such as processes, files etc. These generic gatherers are preferably implemented as Python or shell scripts.

The generic gatherers 21a, 21b . . . 21c then gather generic data (step 106) and send back raw output to the information gathering controller (step 108). After a few minutes of low load on the target machines, these then preferably die without leaving a trace on any of the target machines (step 110). The generic gatherers find processes running, along with files and sockets, and hardware information. This can include tens or hundreds of thousands of processes, files, and sockets.

Generic analyzers in the controller then analyze the raw output from the generic gatherers, yielding graph segments of the process layer, which are added to the model database (step 112). This layer contains low-level notions related to both servers, file systems and processes. This is the layer created when analyzing the individual servers involved in the system.

The controller then sends specific gatherers to each of the machines listed in the SSH private key text file (step 114). One specific gatherer is sent per information item sought per service analyzed. The specific gatherers gather (step 116) and send back raw output from the scripts (step 118), after which they die and no trace remains (step 120). The raw output from the specific gatherers are analyzed by corresponding specific analyzers (step 122), yielding graph segments of both the process layer and service layer, which are added to the model database. The service layer adds services to the model, and roles within services, and couples them to processes and files on the various servers. Two typical examples of roles are master and slave. This layer gives a high level view of the system as interconnected services and service instances when dealing with a service cluster.

The process connector 42 goes over the process layer, using network adapter data to resolve all addresses used by sockets using advanced heuristics (step 124). This information is added to the connection layer of the model, so that it contains the fully resolved network addresses and connection between processes based on such resolved addresses. This includes both live and potential connections. The latter is obtained from parsing configuration files for services.

The service analyzer 44 can then use pattern matching against processes' start commands and files, to connect them to services in the service layer (step 126). The system uses advanced heuristics to recognize services among the many processes and files. The most common services are supported by the system itself, but an SDK is also provided, enabling the addition of new services. Some common services that are supported include MySQL, MongoDB, Apache Server, and NGINX.

The controller can also deploy customized gatherers 26 along with others or in their own separate pass. These can be configured to retrieve specific types of information in particular target networks. They can be built by or for owners of the target network.

Once the model is complete, it can be analyzed (step 128). Analysis tasks include developing a visualization of the system and its various parts, such as process interconnections. This model can be static or interactive, allowing users to select aspects of the system to review or to drill into specific parts of the system. More detailed analyses can include (i) architectural overview of the target system, (ii) analysis of security risks, including improper connection between parts or insecure use of files, (iii) analysis of stability/scalability, including potential single points of failures, and (iv) generating a streamlined automatic deployment harness for a target system, suitable for modern deployment scenarios in public or private clouds.

The system can help the user focus in on parts of the model. In can accomplish this by extracting slices of the model using a filter that returns a transitive closure of a sub graph of the entire model. This can allow an exploratory user interface to allow a user to understand specific parts of the target system. The user interface can show some of the slices or all of the system in three dimensions, and it can also display s sequence of slices to show changes of the system over time. In one embodiment, a query language is used to focus on parts of the model.

### Model

The system 10 uses semantic graphs for both the generated models for Target Systems, called Target Models, and for the Meta Model, which describes the notions appearing in Target Models. The formalism comes from RDF, and the specific language used to describe the Meta Model and Target Models in this document is Turtle, but the crucial part is that semantic graphs are employed rather than RDF and Turtle specifically.

Both the Meta Model and the Target Models consist of three layers or strata, each being a semantic graph, but used together as a combined graph for most applications:
1. Process Layer—contains the information gathered directly from servers, such as processes, files and sockets.
2. Connection Layer—holds connections between communicating processes on same or differing servers.
3. Service Layer—manifests high-level services, abstracted from running processes and files; the services can be distributed and clustered, and have multiple roles, such as master and slaves.

Beside this stratified model, there are also other derived graphs for specific application purposes, such as visualizing the architecture. Those derived graphs need not be semantic graphs. Note that a server can be a physical machine, a virtual machine or a virtualized container, such as a Docker or Rocket container.

The following sections describe each of the aforementioned three strata. A formal specification of each layer, using Turtle specification language and RDF entities is presented in Appendix 1.

### Process Layer

This layer contains low-level notions related to both servers, file systems and processes. This is the layer created when analyzing the individual servers involved in the system.

### Connection Layer

This layer contains the fully resolved network addresses and connection between processes based on such resolved addresses. It also connects processes using file-based sockets.

### Service Layer

This layer adds services, and roles within services, and couple them to processes and files on the various servers. Two typical examples of roles are master and slave. This layer gives a high level view of the system as interconnected services and service instances when dealing with a service cluster.

```
APPENDIX I
Meta Model Specifications
  Turtle Specification of Fundamental (Process) Stratum
    # This is the semantic graph of the Meta Model for the
    # Fundamental Stratum.
    # NOTE: whenever an rdfs:domain is given and rdfs:range is omitted,
    # the range of the attribute is implicitly assumed to be rdfs:Literal;
    # this in order to simplify the specification and depiction of the
    # meta model!
    # RDF Namespaces
    @base <http://dtangle.com/rdf/> .
    @prefix rdf: <http://www.w3.org/1999/02/22-rdf-syntax-ns#> .
    @prefix rdfs: <http://www.w3.org/2000/01/rdf-schema#> .
    @prefix : <network#> .
    @prefix m: <model#> .
    # Concepts For Fundamental Stratum
    :Server a rdf:Class .
    :Machine rdf:subClassOf :Server .
    :Container rdf:subClassOf :Server .
    :Process a rdf:Class .
    :File a rdf:Class .
    :Socket a rdf:Class .
    :Address a rdf:Class .
    :Device a rdf:Class .
    :NetworkAdapter a rdf:Class .
    :User a rdf:Class .
    :Group a rdf:Class .
    # Enums
    :Protocol a rdf:Class .
    :sock_tcp a :Protocol .
    :sock_udp a :Protocol .
    :sock_raw a :Protocol .
    :sock_file a :Protocol .
    :DeviceType a rdf:Class .
    :dev_block a :DeviceType .
    :dev_char a :DeviceType .
    # Properties
    # Properties of Server
    :server_host rdfs:range :Container ; rdfs:domain :Server.
    :run rdfs:domain :Server ; rdfs:range :Process .
    :server_name rdfs:domain :Server .
    :device rdfs:domain :Server ; rdfs:range :Device .
    # Properties of Device
    :dev_path rdfs:domain :Device .
    :dev_type rdfs:domain :Device ; rdfs:range :DeviceType .
    # Properties of NetworkAdapter
    # NOTE: the bag is assumed to contain Address entities
    :addresses rdfs:domain :NetworkAdapter ; rdfs:range rdfs:Bag .
    # Properties of Process
    :pid rdfs:domain :Process .
    :cmd rdfs:domain :Process .
    :args rdfs:domain :Process ; rdfs:range rdf:Seq .
    :env rdfs:domain :Process ; rdfs:range rdf:Bag .
    :proc_owner rdfs:domain :Process ; rdfs:range :User .
    # Properties of Socket
    :sock_address rdfs:domain :Socket ; rdfs:range :Address .
    :sock_port rdfs:domain :Socket .
    :sock_proto rdfs:domain :Socket ; rdfs:range :Protocol .
    # Properties of Address
    :addr_family rdfs:domain :Address .
    # Properties of File
    :file_path rdfs:domain :File .
    :file_mod rdfs:domain :File .
    :file_owner rdfs:domain :File ; rdfs:range :User .
    :file_group rdfs:domain :File ; rdfs:range :Group .
    # Properties of User
    :member rdfs:domain :User ; rdfs:range :Group .
    :user_name rdfs:domain :User .
    :uid rdfs:domain :User .
    # Properties of Group
    :group_name rdfs:domain :Group .
    :gid rdfs:domain :Group .
```

Diagram of Fundamental Stratum

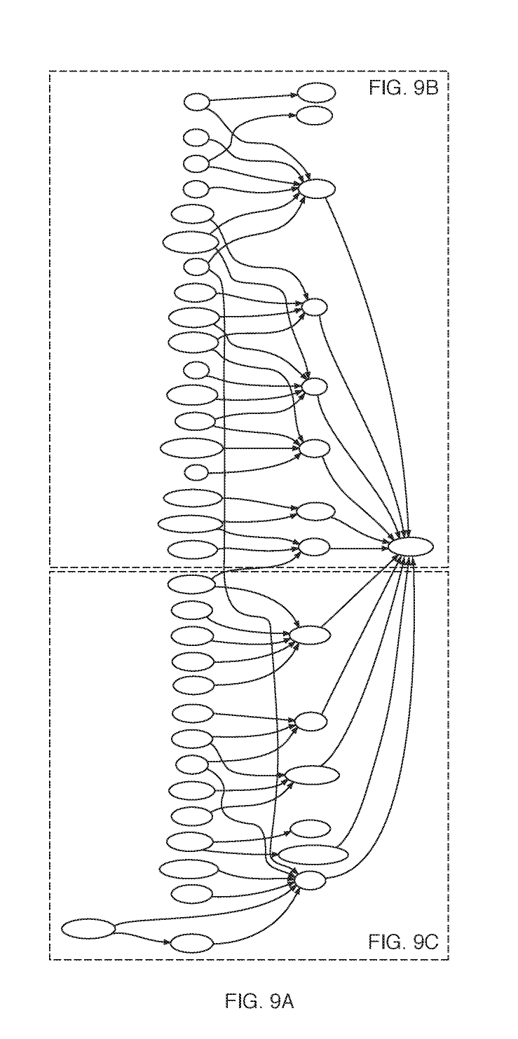

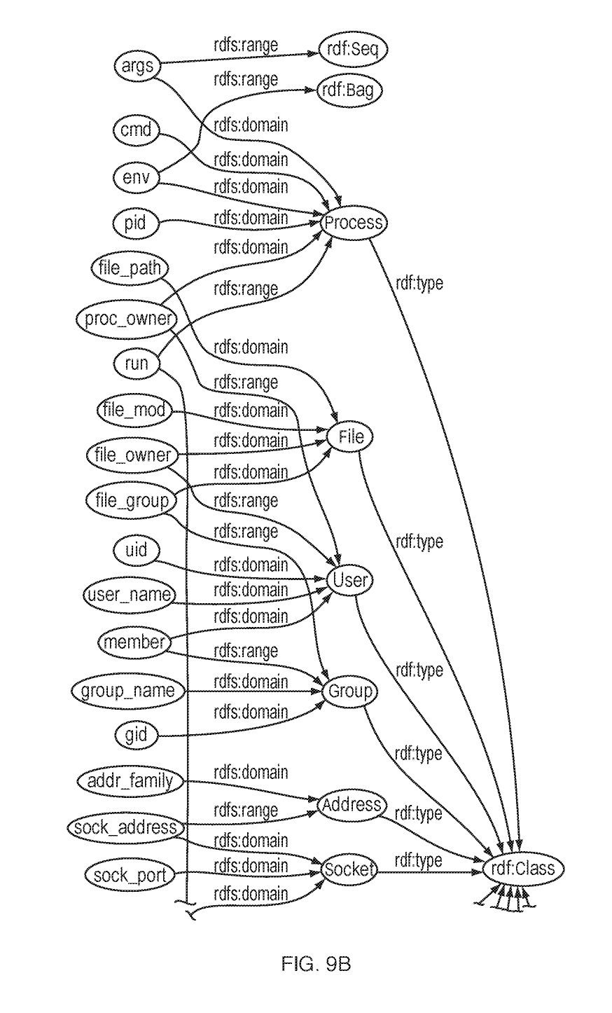

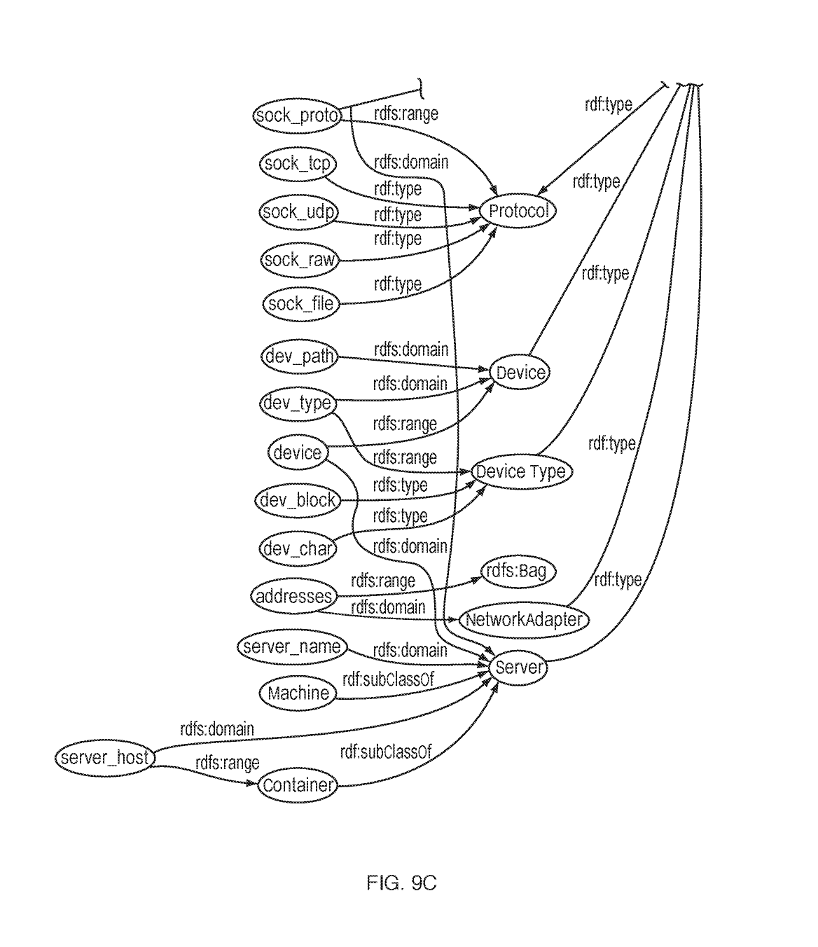

The diagram shown in FIGS. 9A-9C is a visualization of the semantic graph for the Fundamental Stratum of the Meta Model.

Model:
(Unknown)
Namespaces:
rdf: http://www.w3.org/1999/02/22-rdf-syntax-ns#
rdfs: http://www.w3.org/2000/01/rdf-schema#
http://dtangle.com/rdf/fundamental#
m: http://dtangle.com/rdf/model#

```
Turtle Specification of Connection Stratum
  # This is the semantic graph of the Meta Model for the
  # Connection Stratum.
  # NOTE: whenever an rdfs:domain is given and rdfs:range is omitted,
  # the range of the attribute is implicitly assumed to be rdfs:Literal;
  # this in order to simplify the specification and depiction of the
  # meta model.
  # RDF Namespaces
  @base <http://dtangle.com/rdf/> .
  @prefix rdf: <http://www.w3.org/1999/02/22-rdf-syntax-ns#> .
  @prefix rdfs: <http://www.w3.org/2000/01/rdf-schema#> .
  @prefix : <connected#> .
  @prefix f: <fundamental#> .
  @prefix m: <model#> .
  # What the Connection Stratum adds is a set of resolved
  # addresses for a socket and then connection between
  # such addresses
  # A socket can have many resolved addresses
  # TODO: consider using a Bag instead of individual
  # properties
  :resolved rdfs:domain f:Socket; rdfs:range f:Address .
  # The direction of connections is usually from client
  # to server
  :connection rdfs:domain f:Address; rdfs:range f:Address .
```

Diagram of Connected Stratum

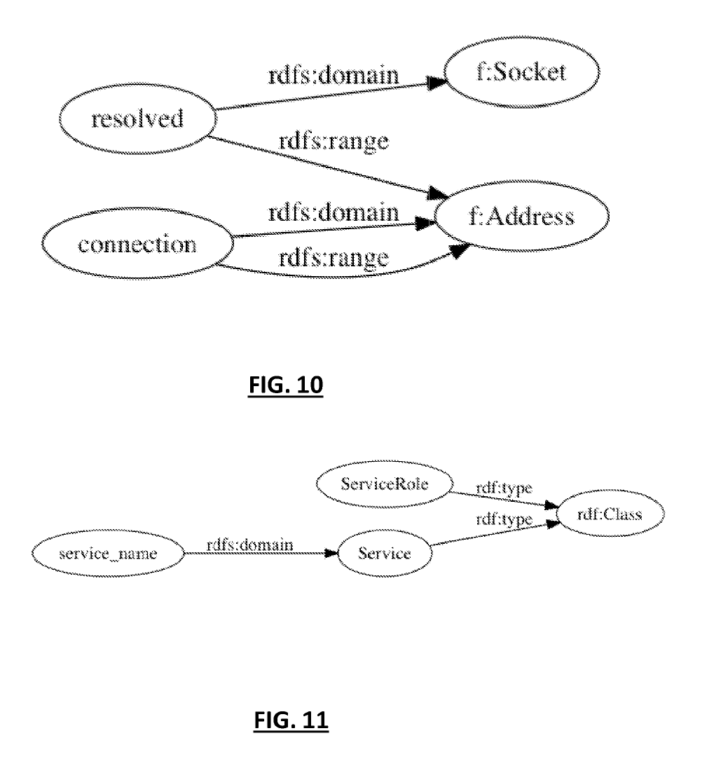

The diagram shown in FIG. 10 is a visualization of the semantic graph for the Connected Stratum of the Meta Model.

Model:
(Unknown)
Namespaces:
rdf: http://www.w3.org/1999/02/22-rdf-syntax-ns#
rdfs: http://www.w3.org/2000/01/rdf-schema#
http://dtangle.com/rdf/connected#
f: http://dtangle.com/rdf/fundamental#
m: http://dtangle.com/rdf/model#

```
Turtle Specification of Service Stratum
  # This is the semantic graph of the Meta Model for the
  # Service Stratum.
  # NOTE: whenever an rdfs:domain is given and rdfs:range is omitted,
  # the range of the attribute is implicitly assumed to be rdfs:Literal;
  # this in order to simplify the specification and depiction of the
  # meta model!
  # RDF Namespaces
  @base <http://dtangle.com/rdf/> .
  @prefix rdf: <http://www.w3.org/1999/02/22-rdf-syntax-ns#> .
  @prefix rdfs: <http://www.w3.org/2000/01/rdf-schema#> .
  @prefix : <service#> .
  @prefix f: <fundamental#> .
  @prefix c: <connected#> .
  @prefix m: <model#> .
  # Each service has a name and is consists of roles, which
  # in turn point to processes
  :Service a rdf:Class .
  :ServiceRole a rdf:Class .
  :service_name rdfs:domain :Service.
  :service_role rdfs:domain :Service ; rdfs:range ServiceRole .
  :role_name rdfs:domain :ServiceRole .
  :role_process rdfs:domain :ServiceRole ; rdfs:range f:Process .
```

Diagram of Service Stratum

This diagram shown in FIG. 11 is a visualization of the semantic graph for the Service Stratum of the Meta Model.

### Model:

### (Unknown)

### Namespaces:

rdf: http://www.w3.org/1999/02/22-rdf-syntax-ns#
rdfs: http://www.w3.org/2000/01/rdf-schema#
http://dtangle.com/rdf/service#
f: http://dtangle.com/rdf/fundamental#
c: http://dtangle.com/rdf/connected#
m: http://dtangle.com/rdf/model#

The system described above can operate using special-purpose hardware, software running on general-purpose processors, or a combination of both. In addition, while the system can be broken into the series of modules shown in FIG. 1, one of ordinary skill in the art would recognize that it is also possible to combine them and/or split them to achieve a different breakdown. The specific implementation of parts of the system including the model, gatherers, and analyzers can also vary depending on a variety of factors, including the objectives for the model and the type of target system being analyzed.

The present invention has now been described in connection with a number of specific embodiments thereof. However, numerous modifications which are contemplated as falling within the scope of the present invention should now be apparent to those skilled in the art. Therefore, it is intended that the scope of the present invention be limited only by the scope of the claims appended hereto. In addition, the order of presentation of the claims should not be construed to limit the scope of any particular term in the claims.

What is claimed is:

1. A computer-based method for automatically detecting characteristics of a computer system that includes a plurality of different running servers connected by a digital communication network, comprising:
running a plurality of resource identification agents over the digital communication network on each of a plurality of different targeted servers in the network,
receiving machine-readable network interface information for the targeted servers from the agents through the digital communication network,
receiving machine-readable information about functionality present on the targeted servers from the agents through the digital communication network,
building and storing a machine-readable model of interactions among the targeted servers in the computer network based on the received information, and
detecting characteristics of the computer system from the stored machine-readable model.

2. The method of claim 1 wherein the step of building and storing a machine-readable model includes storing and building a model that includes information about how sub-systems and high-level services interconnect.

3. The method of claim 1 wherein the step of receiving information about functionality present on the targeted servers includes receiving information about open files, configuration files, operating system files, open sockets, and process-level information present on the servers, and wherein the step of receiving machine-readable network interface information for the targeted servers includes receiving IP addresses for the targeted servers.

4. The method of claim 1 wherein the step of detecting characteristics of the computer system includes detecting network security, stability, scalability, and/or deployment characteristics for the computer system.

5. The method of claim 1 wherein the step of building and storing a model builds and stores a model that includes:
a process layer that contains process-level information for the system derived from the agents,
a connection layer that contains information about communication between processes derived from the fundamental layer, and
a service layer that includes information about services derived from the connected layer.

6. The method of claim 1 wherein the steps of sending, receiving, and building operate on a computer system that includes virtualized servers and virtualized communication layers.

7. The method of claim 1 wherein the step of receiving replies includes a step of receiving information formatted according to the RDF resource discovery model.

8. The method of claim 1 further including the step of displaying a visual representation of the computer system based on the model.

9. The method of claim 1 wherein the step of detecting characteristics of the computer system includes cataloging technologies available on the servers in the computer system.

10. The method of claim 1 further including the step of repeating the steps of running and receiving after an update to the architecture of the computer system, and further including the step of updating the stored model to reflect the updated architecture of the computer system.

11. The method of claim 1 wherein the step of running the agents terminates without leaving any stored information on the servers.

12. The method of claim 1 wherein the steps of running and receiving are performed by generic and specific gatherers.

13. An agent including stored instructions operative to run on a computer system server and report information about the computer system server, comprising:
a network interface gatherer operative to gather machine-readable information about a network interface of the computer system server,
a file information gatherer operative to gather information about files on the computer system server,
a process information gatherer operative to gather information about processes on the computer system server, and
a reporting module operative to report results from the network interface gatherer, the file information gatherer, and the process information gatherer through a communication network to a modeling server.

14. The apparatus of claim 15 wherein the agent is implemented using a scripting language.

15. A computer-based system for automatically detecting characteristics of a computer system that includes a plurality of different running servers connected by a digital communication network, comprising:
means for running a plurality of resource identification agents over the digital communication network on each of a plurality of different targeted servers in the network,
means for receiving machine-readable network interface information for the targeted servers from the agents through the digital communication network,
means for receiving machine-readable information about functionality present on the targeted servers from the agents through the digital communication network,
means for building and storing a machine-readable model of interactions among the targeted servers in the computer network based on the received information, and
means for detecting characteristics of the computer system from the stored machine-readable model.
